(19) United States
(12) Patent Application Publication
(10) Pub. No.: US 2009/0068485 A1
(43) Pub. Date: Mar. 12, 2009

(54) Cationic Surface Sizing Agent and Newsprint Paper

(76) Inventors: Kazushige Inaoka, Kakogawa-shi (JP); Tomohiko Nakata, Kakogawa-shi (JP); Yoshiharu Hashiguchi, Kakogawa-shi (JP)

Correspondence Address: CLARK & BRODY, 1090 VERMONT AVENUE, NW, SUITE 250, WASHINGTON, DC, 20005, US

(21) Appl. No.: 12/084,099

(22) PCT Filed: Oct. 26, 2006
(86) PCT No.: PCT/JP2006/321396

§ 371 Date: Nov. 7, 2008

(30) Foreign Application Priority Data
Oct. 27, 2005 (JP) 2005-312381

(51) Int. Cl. B32B 27/10; C08G 73/00

(52) U.S. Cl. 428/481; 528/363

(57) ABSTRACT

It is an object to improve sizing performance and anti-plate-soiling property in offset printing, for example, in a cationic surface sizing agent to be used for coating base paper of newsprint paper, and as a means for solving the object, a cationic surface sizing agent is produced by quaternizing a copolymer having a weight average molecular weight ranging from 30,000 to 60,000 obtained by polymerizing (a) 20 to 40% by weight of a monomer containing tertiary amino group; (b) 10 to 80% by weight of a C4 to C18 alkyl ester of (meth) acrylic acid; and (c) 0 to 70% by weight of a styrene or derivative thereof, using an azoic polymerization initiator in the presence of a chain transfer agent. In this manner, it is possible to improve sizing performance without reducing the hydrophobic level of copolymer and to suppress sensitization of printing plate such as PS plate by specifying the monomer composition ratio, using an azoic polymerization initiator, and specifying molecular weight of the copolymer.

### FIELD OF THE INVENTION

The present invention relates to a cationic sizing agent having sizing performance and anti-soiling property in offset printing.

### BACKGROUND ART

In offset printing of newsprint paper, improvement in quality of paper to respond to recent demands of high-speed and multi-color printing; environmental adaptation of offset ink from care of environment in printing; switchover of dampening water from alkaline etching water to fresh water, or reduction of quantity of dampening water have been attempted.

On the other hand, since newsprint paper is request to have higher water resistance to respond to the demands of super-light weight, neutralization, high-speed printing and high quality, not only a sizing agent is internally added at the time of making base paper but also on-machine coating is made while mixing a surface sizing agent and starches after papermaking.

In particular, for the purpose of improving operability in papermaking, or reducing rise in papermaking pH due to neutralization and reducing pollution in a papermaking system when calcium carbonate is internally added as a filler, water resistance (size degree) of newsprint paper is improved by reducing the quantity of internal sizing agent, or increasing a coating amount of surface sizing agent after papermaking rather than adding a sizing agent internally.

In such a circumstance, particularly in neutral paper, coating with a cationic surface sizing agent is employed because an existent anionic surface sizing agent has poor effect.

The above cationic surface sizing agent is generally composed of an aqueous solution of tertiary amine salt or quaternary ammonium salt of copolymer based on styrene or derivative thereof and the monomer containing tertiary amino group (namely, cationic monomer), and the copolymer is synthesized by polymerization using an organic peroxide-based polymerization initiator or an azoic polymerization initiator such as azobis isobutyronitrile in an organic solvent or in a mixed solvent of organic solvent and water, or by emulsion polymerization by using peroxosulfate or a water-soluble azoic polymerization initiator, water-soluble peroxide and a reducing agent or the like in a water-based solvent.

The cationic surface sizing agent has strong adhesion to anionic pulp, and dry film thereof is difficult to be solved in water, from the view points of its purpose and property.

As prior arts of cationic surface sizing agent, the following can be exemplified.

### (1) Patent Document 1

Disclosed is a surface sizing agent in which a cationic hydrophobic polymer obtained by polymerization of 90 to 60% by mol of (a) styrene or derivative thereof, 0 to 30% by mol of (b) tertiary amino group- or quaternary amino group-containing monomer, and 0 to 10% by mol of (c) other vinyl monomer ((meth)acrylic acid ester, vinyl acetate, acrylonitrile, acrylamides, (meth)acrylic acid or the like) in an organic solvent, is mixed with cationated starch for the purpose of improving the sizing effect (see claims 1 to 6, paragraphs 6 to 7).

### (2) Patent Document 2

Disclosed is a cationic high-molecular emulsion usable as an internal sizing agent or a surface sizing agent, produced by adding to water, a copolymer having monomer composition of 50 to 98.5% by mol of (1) styrene or derivative thereof, 0.1 to 9.9% by mol of (2) dialkylaminoalkyl (meth)acrylic acid ester or its salt, 0.1 to 10% by mol of (3) quaternary compound of the above (2), and 0 to 48.5% by mol of (4) (meth)acrylic acid alkyl ester, the total amount of (2) and (3) being 1.5 to 10% by mol, and obtained by solution polymerization or bulk polymerization, for the purpose of imparting excellent sizing performance and disaggregativity to product paper (see claims, pages 2 to 3).

### (3) Patent Document 3

Disclosed is a cationic surface sizing agent containing cationic copolymer (A) obtained by quaternizing a copolymer of a hydrophobic monomer and a monomer having tertiary amino group with oxides, or a cationic surface sizing agent containing a copolymer obtained by polymerization (especially emulsion polymerization: see paragraph 25) of hydrophobic monomer (B) such as styrene or derivative thereof or (meth)acrylic acid ester in the presence of cationic copolymer (A), for the purpose of reducing generation of floating substances in polymerization, improving sizing performance and inkjet suitability and reducing foamability (see claims 1 to 6).

### (4) Patent Document 4

Disclosed is a cationic surface sizing agent containing a copolymer obtained by polymerizing (especially emulsion polymerization: see paragraph 29) of a hydrophobic monomer (B) such as styrene or derivative thereof or (meth)acrylic acid ester, in the presence of a mixture of a cationic copolymer (A-1) obtained by quaternizing a copolymer of hydrophobic monomer and a monomer having tertiary amino group, and a nonionic surfactant (A-2), for the purpose of reducing generation of floating substances in polymerization, improving sizing performance and inkjet suitability and reducing foamability (see claims 1 to 3).

### (5) Patent Document 5

Disclosed is a surface sizing agent obtained by emulsion polymerization of hydrophobic monomer (C) such as styrene or derivative thereof or (meth)acrylic acid ester using as an emulsion dispersing agent, cationic copolymer (B) obtained by quaternizing copolymer (A) of styrene or derivative thereof (a) and dialkylaminoalkyl (meth)acrylamide (b) for the purpose of improving sizing effect.

### (6) Patent Document 6

Disclosed is using (meth) acrylic acid dialkylamino alkyl ester(b) in place of dialkylamino alkyl (meth)acryl amide (b) in the former stage, and a monomer mixture of styrene or derivative thereof and (meth)acrylic acid ester as hydrophobic monomer (C) in the latter stage, in the above Patent document 5.

### (7) Patent Document 7

Disclosed is an application of a sizing agent comprising a water-soluble or water-dispersible copolymer having monomer composition of: styrene or derivative thereof, and dialkylamino alkyl(meth)acrylate and/or dialkylamino alkyl(meth)acrylamide, to transfer paper for electrophotography bearing calcium carbonate as a filler (see claims). In this case, use proportion of styrene or derivative thereof is 40 to 95% by mol (see right upper column of page 3).

### (8) Patent Document 8

Disclosed is a surface sizing agent obtained by quaternizing a copolymer containing 95 to 50% by mol of styrene or derivative thereof, and 5 to 50% by mol of dialkylamino alkyl(meth)acrylamide, for the purpose of improving rust resistance and sizing performance (see claims).

### (9) Patent Document 9

Disclosed is a cationic surface sizing agent of a terpolymer in aqueous liquid form. The terpolymer is composed of 8 to 20% by weight of (a) dimethylaminoethyl(meth)acrylate, 45 to 80% by weight of (b) styrene, and 8 to 35% by weight of (c) acrylonitrile (preferably, component (a) is 8 to 20% by weight, component (b) is 55 to 75% by weight, and component (c) is 10 to 30% by weight), and at least 10% of dimethyl amino groups is quaternized (see claims 1 to 2).

[Patent document 1] Japanese Unexamined Patent Publication No. 11-323774

[Patent document 2] Japanese Unexamined Patent Publication No. 4-34097

[Patent document 3] Japanese Unexamined Patent Publication No. 2001-295197

[Patent document 4] Japanese Unexamined Patent Publication No. 2001-262495

[Patent document 5] Japanese Unexamined Patent Publication No. 11-279983

[Patent document 6] Japanese Unexamined Patent Publication No. 11-256496

[Patent document 7] Japanese Unexamined Patent Publication No. 3-167397

[Patent document 8] Japanese Unexamined Patent Publication No. 2-26997

[Patent document 9] Japanese Unexamined Patent Publication No. 56-118994

### DISCLOSURE OF THE INVENTION

### Problems to be Solved by the Invention

In general, in offset printing, ink is transferred to both to printing areas and nonprinting areas of PS plate (presensitized plate) which is a print original plate from an ink roller. Since the ink on a hydrophilic nonprinting area of PS plate is usually removed from the PS plate in short time printing, and the nonprinting area of the PS plate will not be stained with ink after that, normal printing without ink adhesion is realized in the nonprinting area of printing face.

However, in newsprint paper using a conventional cationic surface sizing agent, a surface sizing agent applied on the newsprint paper transfers onto a PS plate via the dampening water during printing, and remains permanently on the PS plate, leading to sensitization of the nonprinting area of the PS plate which should be essentially hydrophilic. When such sensitization occurs, the nonprinting area of the PS plate is supplied with ink permanently, so that a problem arises that the phenomenon that ink adheres to the nonprinting area in printing surface where ink should not adhere by right is likely to occur.

This problem is more likely to occur, particularly in the trend of recent years that the sizing performance of newsprint paper is improved by coating with more surface sizing agent for responding to increased quality, and neutralization of base paper of newsprint paper.

Also in the surface sizing agents disclosed in the above Patent documents 1 to 9, it is difficult to escape from the adverse affect that plate soiling called, for example, “scumming” is caused by sensitization of nonprinting areas of PS plate.

In addition, since the above Patent documents 1 to 9 as a whole employ styrene or derivative thereof as a base of hydrophobic monomer, copolymerizability is not necessarily good, and when paper without internal sizing agent is coated with the obtained surface sizing agent, it is not easy to ensure sufficient sizing performance, and it is still impossible to satisfy both the sizing performance and anti-plate-soiling property.

Therefore, it is a primary object of the present invention to improve sizing performance and anti-plate-soiling property in offset printing.

### Means for Solving the Problems

The present inventors made diligent efforts to solve the above problem, and found that in production of a cationic surface sizing agent comprising a copolymer, by specifying composition ratio of cationic monomer and hydrophobic monomer while roughly regulating proportion of styrene or derivative thereof, causing copolymerization using an azoic polymerization initiator in the presence of a chain transfer agent, quaternizing the obtained copolymer, and specifying a molecular weight of the copolymer, it is possible to improve the sizing performance without decreasing the level of hydrophobicity of the copolymer, and it is possible to control sensitization of PS plate by reducing elution amount of the surface sizing agent by dampening water in offset printing, and it is possible to impart an appropriate affinity to print ink to the copolymer, and accomplished the present invention.

A cationic surface sizing agent according to the present invention comprises a quaternized copolymer, of which a copolymer has a weight average molecular weight ranging from 30,000 to 60,000 and is obtained by copolymerizing (a) 20 to 40% by weight of a monomer containing tertiary amino group, (b) 10 to 80% by weight of a C4 to C18 alkyl ester of (meth)acrylic acid, and (c) 0 to 70% by weight of a styrene or derivative thereof using an azoic polymerization initiator in the presence of a chain transfer agent, and has anti-plate-soiling property in offset printing.

Newsprint paper according to the present invention is newsprint paper for offset printing in which surface of base paper is coated with the cationic surface sizing agent according to the present invention.

### EFFECTS OF THE INVENTION

Since the cationic surface sizing agent according to the present invention is obtained by specifying a monomer composition while regulating proportion of styrene or derivative thereof, in particular, lower than that in conventional cases, copolymerizing using an azoic polymerization initiator in the presence of a chain transfer agent, and quaternizing the obtained copolymer while keeping the molecular weight thereof in a specific range, high sizing performance and appropriate affinity to print ink are imparted to the copolymer, so that washability is improved even with dampening water such as fresh water.

Accordingly, when base paper of newsprint paper or the like is coated with the surface sizing agent according to the present invention, it is possible to reduce the eluting amount of the surface sizing agent by dampening water, and the surface sizing agent having transferred to printing plate such as PS plate via the dampening water from the coated newsprint paper can be readily removed from nonprinting areas together with the adhered ink. Therefore, sensitization of printing plate is not retained, and soiling due to sensitization in offset printing can be desirably prevented.

Therefore, the surface sizing agent according to the present invention is excellent in sizing performance, and is insusceptible to soiling due to sensitization even when coating amount to base paper of newsprint paper is increased from the view point of improving the sizing performance, and has excellent anti-plate-soiling property, and is particularly excellent in anti-plate-soiling property for PS plate for newspaper printing. Therefore, the surface sizing agent according to the present invention is suited for surface sizing of newsprint paper for high-performance offset printing.

### PREFERRED EMBODIMENTS FOR CARRYING OUT THE INVENTION

The cationic surface sizing agent according to the present invention comprises a quaternized copolymer, which is produced by quaternizing a part or whole of a copolymer having a weight average molecular weight of 30,000 to 60,000, obtained by copolymerizing (a) 20 to 40% by weight of a monomer containing tertiary amino group, (b) 10 to 80% by weight of a C4 to C18 alkyl ester of (meth)acrylic acid, and (c) 0 to 70% by weight of a styrene or derivative thereof using an azoic polymerization initiator in the presence of a chain transfer agent.

As the monomer containing tertiary amino group (a) which is a constituting component of the copolymer according to the present invention, for example, dialkylaminoalkyl (meth)acrylate, and dialkylaminoalkyl (meth)acrylamide are appropriate.

Examples of the dialkylaminoalkyl (meth)acrylate include dimethylaminoethyl (meth)acrylate, dimethylaminopropyl (meth)acrylate, diethylaminoethyl (meth)acrylate, dimethylaminopropyl (meth)acrylate, and diethylaminopropyl (meth)acrylate, and among these, dimethylaminoethyl (meth)acrylate, diethylaminoethyl (meth)acrylate, and dimethylaminopropyl (meth)acrylate are particularly preferred.

Examples of the dialkylaminoalkyl (meth)acrylamide include dimethylaminoethyl (meth)acrylamide, diethylaminoethyl (meth)acrylamide, dimethylaminopropyl (meth)acrylamide, and diethylaminopropyl (meth)acrylamide, and among these, dimethylaminoethyl (meth)acrylamide, and dimethylaminopropyl (meth)acrylamide are particularly preferred.

As C4 to C18 alkyl ester of (meth)acrylic acid (b) which is a constituting component of the copolymer according to the present invention, cyclic or acyclic hydrocarbon esters such as n-butyl (meth)acrylate, isobutyl (meth)acrylate, ethylhexyl (meth)acrylate, lauryl (meth)acrylate, cetyl (meth)acrylate, stearyl (meth)acrylate, cyclohexyl (meth)acrylate, and benzyl (meth)acrylate can be recited. As described above, (meth)acrylic acid ester of component (b) may be those containing an aromatic or alicyclic hydrocarbon group in their ester parts, as well as alkyl (meth)acrylate having C4 to C18 alkyl group.

Although component (b) does not include C1 to C3 alkyl ester of (meth)acrylic acid (namely, short-chain ester) such as methyl methacrylate (abbreviated as MMA), it goes without saying that such short-chain ester of (meth)acrylic acid may be used as other monomers than components (a) to (c) in obtaining the copolymer according to the present invention as will be described later.

Preferred examples of component (b) include ethylhexyl methacrylate, lauryl methacrylate, stearyl methacrylate, cyclohexyl methacrylate, and benzyl methacrylate.

As the above styrene or derivative thereof (c), styrene, α-methylstyrene, vinyltoluene, ethylvinyltoluene, chloromethylstyrene and the like can be recited.

In polymerization of copolymer constituting a surface sizing agent according to the present invention, other copolymerizable vinyl monomers than the above components (a) to (c) may be optionally used.

Examples of the aforementioned other monomers include C1 to C3 short-chain alkyl (meth)acrylates such as methyl (meth)acrylate, ethyl (meth)acrylate, n-propyl (meth)acrylate and isopropyl (meth)acrylate, hydroxyl group containing (meth)acrylates such as hydroxypropyl (meth)acrylate and 2-hydroxyethyl (meth)acrylate, (meth)acrylamide, and acrylonitrile.

Therefore, for example, a copolymer containing component (a), and/or component (c) and using C4 to C18 long-chain alkyl ester and C3 or shorter short-chain alkyl ester as (meth)acrylic acid ester is regarded as a copolymer according to the present invention, however, a copolymer using only C3 or shorter short-chain alkyl (meth)acrylate as (meth)acrylic acid ester and not using C4 to C18 long-chain alkyl ester is not regarded as a copolymer according to the present invention. In (meth)acrylic acid ester, the larger the number of carbons in ester, the higher the contribution to water-repellency which is a basic property of sizing agent.

Next, proportion of each monomer constituting the copolymer according to the present invention will be described.

Content of the monomer containing tertiary amino group (a) is 20 to 40% by weight, and preferably 22 to 35% by weight, based on the total amount of monomers. If the content is less than 20% by weight, solubility upon water solubilization decreases, whereas if the content is more than 40% by weight, hydrophobicity decreases to lead to impairment of sizing effect.

Content of C4 to C18 ester of (meth)acrylic acid (b) is 10 to 80% by weight, and preferably 15 to 70% by weight based on the total amount of monomers. If the content is less than 10% by weight, hydrophobicity decreases, and solubility decreases upon solution polymerization, so that copolymerizability is impaired and affinity to ink is reduced. If the content is more than 80% by weight, the proportion of the monomer containing tertiary amino group (a) is too small. That is, an appropriate amount of component (b) is required as a hydrophobic monomer in order to have good affinity to ink.

Content of styrene or derivative thereof (c) is 0 to 70% by weight, and preferably 0 to 60% by weight based on the total amount of monomers. If the content is more than 70% by weight, affinity to ink is decreased, and copolymerizability upon solution polymerization is impaired. Impairment in copolymerizability may result in reduction in sizing effect because active ingredients of the surface sizing agent are scattered on paper surface in the forms of aggregated microparticles and the formed cover is ununiform when a coating liquid is prepared after water-solubilization and quaternization following solution polymerization. However, as shown in Examples described later, since styrene or derivative thereof (c) is superior in hydrophobicity to (meth)acrylic acid ester, an appropriate amount may be contained in copolymer without leading to any problem.

Further, other monomers may be used as necessary in a content of 0 to 30% by weight, preferably 0 to 20% by weight, based on the total amount of monomers.

Basically, a copolymer according to the present invention is produced by solution polymerization in an organic solvent from components (a) to (c) as constituting monomers. Although polymerization method in the present invention is not limited to solution polymerization, the following explanation will be made for the case where solution polymerization is employed.

As the organic solvent, oxygen containing hydrocarbons such as alcohol and ketone, and aromatic hydrocarbons such as toluene can be exemplified. Concrete examples include isopropyl alcohol (abbreviated as IPA), n-butanol, isobutanol, t-butanol, sec-butanol, methylethyl ketone, methyl-n-propyl ketone, 3-methyl-2-butanol, diethyl ketone, methylisopropyl ketone, methyl isobutyl ketone (abbreviated as MIBK), diisoporpyl ketone, ethyl benzene, and toluene.

Using an organic solvent having a boiling point of 150° C. or higher and an appropriate water solubility (appropriate hydrophilicity) is effective for suppressing odor during coating with the surface sizing agent. Such effect is concretely obtained by propylene glycol, propylene glycol diacetate, benzyl alcohol, 1,3-butylene glycol, hexylene glycol and the like.

Using amount of organic solvent based on the total monomer amount is appropriately not more than 30% by weight, and preferably not more than 20% by weight.

In the present invention, it is important to conduct polymerization using an azoic polymerization initiator in the presence of a chain transfer agent from the view point of preventing increase in viscosity and allowing smooth polymerization reaction upon the solution polymerization (see comparative examples using surface sizing agents in later-described Comparative examples 1-1 to 1-2, 1-4, 1-7).

As the chain transfer agent, any of oil-soluble, water-soluble chain transfer agents may be used, however, an oil-soluble chain transfer agent is preferred in the case of polymerization in a lipophilic organic solvent, and a water-soluble chain transfer agent is relatively preferred in the case of using a hydrophilic organic solvent.

Examples of the oil-soluble chain transfer agent include mercaptans such as t-dodecyl mercaptan, n-dodecyl mercaptan, n-octyl mercaptan and mercaptopropionic acid dodecyl ester, cumene, carbon tetrachloride, α-methyl styrene dimmer, and terpinolene.

As the above water-soluble chain transfer agent, mercaptoethanol, tioglycolic acid and its salt and the like can be exemplified.

Use amount of the chain transfer agent, based on the total monomer amount is preferably, but is not limited to, about 1 to 5% by weight.

As described above, the polymerization initiator used in the present invention is an azoic polymerization initiator. That is, in order to prevent increase in molecular weight due to cross-linking caused by hydrogen abstraction, and reduction in solubility due to complicated molecular structure associated with branching, peroxide-based polymerization initiators such as benzoyl peroxide, t-butyl peroxybenzoate, t-butyl peroxyisopropyl monocarbonate, t-butyl peroxy-2-ethylhexanoate, and cumene hydroperoxide are excluded.

As the above azoic polymerization initiator, azobis methylbutyronitrile, dimethyl azobis isobutylate, azobis dimethylvaleronitrile, azobis isobutyronitrile (abbreviated as AIBN) and the like can be exemplified. Among these, solubility (25° C.) of the azoic polymerization initiator to ethanol is preferably not less than 15 g/100 g from the view point of increasing solubility to solvent and constituting monomers of copolymer in solution polymerization. Examples of the azoic polymerization initiator satisfying the above solubility to ethanol include azobis methylbutyronitrile, dimethyl azobis isobutylate, and azobis dimethylvaleronitrile.

As described above, in the present invention, polymerization, preferably solution polymerization is conducted in an organic solvent in the presence of a chain transfer agent and an azoic initiator, and the solution polymerization is not particularly limited insofar as it is carried out according to a method known in the art.

A copolymer that is obtained by solution polymerization from the above components (a) to (c) and other components as necessary as constituting monomers is cationized by a quaternizing agent.

As the above quaternizing agent, dimethyl sulfuric acid, methyl chloride, allyl chloride, benzyl chloride, propylene oxide, butylene oxide, styrene oxide, epichlorohydrin, epibromohydrin, ethylene chlorohydrin, 3-chloro-2-hydroxypropyl trimethylammonium chloride and the like may be used alone or in combination. Among these quaternizing agents, epichlorohydrin, benzyl chloride, and 3-chloro-2-hydroxypropyl trimethylammonium chloride are preferred.

In quaternization, it is preferred to quaternize 50 to 100% by mol of tertiary amino groups possessed by a copolymer to completely or partly quaternize the copolymer.

By quaternizing the copolymer, solubility is improved in wider pH region including neutral and alkaline sides, and excellent sizing effect can be exerted.

This quaternizing process is generally conducted by removing a solvent and quaternizing a copolymer after water-solubilizing a cationic copolymer, however, solvent may be removed after quaternization.

In the present invention, the quaternizing process is basically conducted by cationation with a quaternizing agent after copolymerization of constituting monomers including the monomer containing tertiary amino group (a) from the view point of smoothing the solution polymerization, however, it is also possible to obtain a cationic surface sizing agent of the present invention by quaternizing the monomer containing tertiary amino group (a) in advance and polymerizing the obtained quaternized ammonium base containing monomer. Polymerization conditions in this case (the case of copolymerizing after making quaternary monomer) are as same as the processing conditions in polymerizing tertiary monomer.

The cationic surface sizing agent according to the present invention has anti-plate-soiling property in offset printing. Therefore, the cationic surface sizing agent according to the present invention may be applied to various printing plates in offset printing, and in particular, suitably applied to PS plate (original plate) of offset newspaper printing.

The cationic surface sizing agent according to the present invention may be applied onto a variety of base paper regardless of type, including paper made by acidic papermaking using aluminum sulfate as a fixing agent, and paper made by neutral papermaking using at least calcium carbonate as a filler. Paper made by neutral papermaking for offset printing having very small Stockigt sizing degree, namely neutral base paper of newsprint paper for offset printing is particularly preferred because of excellent anti-plate-soiling property in offset printing. It goes without saying that it may be applied onto other paper such as inkjet recording paper, thermosensitive recording base paper, pressure sensitive recording base paper, bond paper, and paperboard, besides base paper of newsprint paper for offset printing. Basically, the surface sizing agent according to the present invention does not need to be combined with an internal sizing agent, however, application to base paper containing an internal sizing agent is not excluded.

In coating with the cationic surface sizing agent according to the present invention, coating amount of the sizing agent differs depending on the kind of paper. It is also possible to vary the coating form by thinly coating with a concentrated coating liquid or thickly coating with a coating liquid of low concentration. Further, one side or on both sides may be coated. Therefore, coating amount of the surface sizing agent is not definitely limited, however, in coating of base paper of newsprint paper for offset printing, the amount is generally about 0.01 to 0.2 g/m², and preferably about 0.02 to 0.1 g/m² per one side by solid content weight.

It goes without saying that the cationic surface sizing agent according to the present invention may be applied to base paper of newsprint paper together with a water-soluble high molecular compound which is a binder, likewise the case of producing usual newsprint paper. The water-soluble high molecular compound is effective for increasing surface strength of newsprint paper and preventing occurrence of paper powder in printing.

As the water-soluble high molecular compound, starches such as starch, enzyme-modified starch, thermochemically-modified starch, oxidized starch, esterified starch, eterized starch (for example, hydroxyethylated starch), and cationized starch; polyvinyl alcohols such as polyvinyl alcohol, fully-saponificated polyvinyl alcohol, partially-saponificated polyvinyl alcohol, carboxyl-modified polyvinyl alcohol, silanol-modified polyvinyl alcohol, cation-modified polyvinyl alcohol and terminal alkyl-modified polyvinyl alcohol; polyacrylamides such as polyacrylmide, cationic polyacrylmide, anionic polyacrylmide and amphoteric polyacrylmide; and cellulose derivatives such as carboxymethyl cellulose, hydroxyethyl cellulose and methyl cellulose may be used alone or in combination.

An amount of the water-soluble high molecular compound is determined by a target value of surface strength of newsprint paper, and an amount of the cationic surface sizing agent according to the present invention is mainly determined by a target value of water-absorption resistance of newsprint paper. From this point, a blending ratio of water-soluble high molecular compound and cationic surface sizing agent is not particularly defined. However, it is usually appropriate to blend 1 to 50 parts by weight, preferably 15 to 40 parts by weight, more preferably 20 to 40 parts by weight of cationic surface sizing agent based on 100 parts by weight of water-soluble high molecular compound.

A coating liquid containing a surface sizing agent as active ingredient may also contain auxiliary agents such as cohesion preventing agent, antiseptic agent, antifoaming agent, lubricant, antilubricant, UV-ray preventing agent, antifading agent, fluorescent brightening agent, viscosity stabilizer and the like as far as adverse affect is not exerted on the water-absorption resistance.

Base paper of newsprint paper in the present invention is obtained by mixing mechanical pulp (MP) such as grand pulp (GP), thermomechanical pulp (TMP), chemithermomechanical pulp (CTMP) and semichemical pulp (SCP); chemical pulp (CP) represented by kraft pulp (KP), sulfite pulp (SP); deinking pulp (DIP) which is obtained by removing ink from waste paper containing such pulp; and recovery pulp obtained by defiberizing loss paper from papermaking process, singly or in an arbitrary ratio, and making paper by a papermaking machine which is known and used in the art. In recent years, demand to blend DIP in higher proportion is increased in association with increased interest in environmental protection, so that blending proportion of DIP is preferably 50 to 100% by weight.

In base paper of newsprint paper according to the present invention, white carbon, clay, silica, talc, titanium oxide, calcium carbonate, synthetic resin filler (vinyl chloride resin, polystyrene resin, urea formalin resin, melaminic resin, styrene-butadiene copolymer resin and the like) and the like may be used as a filler as is necessary. Internal paper strength improving agents such as polyacrylamide-based polymer, polyvinyl alcohol-based polymer, cationic starch, urea-formalin resin and melamine-formalin resin; water filterability and/or yield improving agents such as salt of copolymer of acrylamide and aminomethyl acrylamide, cationic starch, polyethylene imine, polyethylene oxide and copolymer of acrylamide and sodium acrylate; internal sizing agents such as rhodine-based sizing agent, AKD, ASA, petroleum-based sizing agent and neutral rhodine sizing agent; UV-ray preventing agent, antifading agent and the like auxiliary agents may also be contained.

When base paper of newsprint paper is coated with the cationic surface sizing agent according to the present invention, coating may be conducted using a usual coater for papermaking. For example, 2-roll size press, blade metaring size press, rod metaring size press, gate roll coater, bar coater, air knife coater, spray coater and the like apparatuses can be recited. Among these apparatuses, film transfer type coaters represented by a gate roll coater are desired. In the case of base paper of newsprint paper for offset printing, in particular, a gate roll coater (GRC) is widely used among these apparatuses, and used most preferably in the present invention as well.

Although coating speed is not particularly limited insofar as it is comparable to papermaking speed of a typical papermaking machine capable of producing newsprint paper, it is typically in the range of 800 to 2500 m/min. By coating at such high speed as 800 m/min. or higher, the coating liquid is dried before it sufficiently penetrates into paper layer, and a substantial amount of coating liquid resides near superficial face, so that it is possible to prevent fibers existing in the superficial face of paper from swelling more effectively in absorption of water.

Newsprint paper for offset printing according to the present invention is preferably subjected to calender process after coating of the surface sizing agent and drying in order to obtain the paper thickness and smoothness that are suited for offset printing. As a calender, a generally used hard nip calender, or a hot soft nip calender (see for example, Paper and Pulp Technical Times Vol. 43, No. 1 (2000), pp. 23) can be recited. In consideration of lightening in weight of future newsprint paper, a soft nip calender is more preferred.

### EXAMPLES

In the following, examples of cationic surface sizing agent according to the present invention, examples of newsprint paper obtained by coating base paper with surface sizing agents obtained in these examples, test examples of evaluation of sizing performance of newsprint paper obtained in these examples, test examples of evaluation of anti-plate-soiling property, and test examples of evaluation of printing will be sequentially explained. The term “part” and “%” in these examples and test examples are based on weight unless otherwise specified.

It goes without saying that the present invention is not restricted by the following examples and test examples, but may be arbitrarily changed within the spirit and scope of the present invention.

### <Examples of Surface Sizing Agent>

Among Examples 1-1 to 1-6, Example 1-2 is an example in which weight average molecular weight of copolymer is near the lower limit of appropriate range of the present invention, and Example 1-5 is an example in which the molecular weight is near the upper limit of appropriate range of the present invention. Example 1-3 is an example in which styrene or derivative thereof (c) is not used, and proportion of (meth)acrylic acid ester (b) is large; Examples 1-2 and 1-6 are examples in which proportion of component (c) is larger, and proportion of component (b) is small; Example 1-5 is an example in which proportion of the monomer containing tertiary amino group (a) is large; and Example 1-4 is an example in which proportion of component (a) is small. Examples 1-5 are example in which solubility of azoic polymerization initiator to ethanol is out of the aforementioned preferred range, and other Examples are examples in which the preferred range is satisfied. Examples 1-1, 1-3 and 1-5 are examples in which tertiary amino groups of copolymer are fully quaternized, while Examples 1-2, 1-4 and 1-6 are examples in which they are partially quaternized. Examples 1-1 to 1-3 and 1-5 are examples in which quaternization is made with epichlorohydrin, and Examples 1-4 and 1-6 are examples in which other kind of quaternizing agent (such as benzyl chloride) is used. Example 1-3 is an example in which quantity of solvent is reduced and a distillation step is omitted, and other Examples are examples in which solvent is distilled off.

On the other hand, among Comparative examples 1-1 to 1-10, Comparative example 1-1 is an example in which weight average molecular weight of copolymer is larger than the appropriate range of the present invention, proportion of the monomer containing tertiary amino group (a) is larger than the appropriate range of the present invention, and a nonazoic polymerization initiator is used. Comparative example 1-2 is an example in which the molecular weight is larger than the appropriate range, proportion of (meth)acrylic acid ester (b) is smaller than the appropriate range of the present invention, proportion of styrene or derivative thereof (c) is larger than the appropriate range, and a nonazoic initiator is used. Comparative example 1-3 is an example in which the molecular weight is larger than the appropriate range and proportion of component (b) is smaller than the appropriate range although an azoic initiator is used. Comparative example 1-4 is an example in which the molecular weight is larger than the appropriate range, MMA is used as well as component (b) of the present invention for (meth) acrylic acid ester, and a nonazoic initiator is used. Comparative example 1-5 is an example in which conditions of monomer proportion and azoic initiator are satisfied, but the molecular weight is larger than the appropriate range. Comparative example 1-6 is an example in which conditions of monomer proportion and azoic initiator are satisfied, but the molecular weight is smaller than the appropriate range. Comparative example 1-7 is an example in which conditions of molecular weight and monomer proportion are satisfied, but a nonazoic initiator is used. Comparative example 1-8 is an example in which conditions of molecular weight and azoic initiator are satisfied, but proportion of component (b) is smaller than the appropriate range, and proportion of styrene or derivative thereof (c) is larger than the appropriate range. Comparative example 1-9 is an example in which condition of azoic initiator is satisfied, but only MMA is used for (meth)acrylic acid ester, and the molecular weight is larger than the appropriate range. Comparative example 1-10 is an example in which conditions of monomer composition and azoic initiator are satisfied, but polymerization is conducted without a chain transfer agent.

### (1) Example 1-1

50 parts of styrene, 20 parts of 2-ethylhexyl methacrylate, 30 parts of dimethylaminopropyl acrylamide, 2 parts of n-dodecyl mercaptan which is a chain transfer agent, and 42.7 parts of isopropyl alcohol were put into a four-necked flask, heated to 85° C., added with 2.5 parts of 2,2-azobis-2-methylbutyronitrile as an initiator (solubility to ethanol at 25° C.: 75 g/100 g ethanol), and allowed to polymerize at 90° C. for 3 hours.

The reaction was sampled and molecular weight was measured by Shodex GPC system-21H (column GF-7M, GF-310, solvent DMF, value in terms of polystyrene), to reveal that the weight average molecular weight was 43,000 (weight average molecular weights of copolymer in the following Examples and Comparative examples were also measured in a similar manner).

Then 340 parts of water, and 12.8 parts of 90% acetic acid were added to make the reaction water-soluble, and then isopropyl alcohol was distilled off by distillation under heating. Thereafter, 17.7 parts of epichlorohydrin was added at 85° C. and allowed to react for 3 hours, followed by cooling and dilution in water, to give a surface sizing agent having a solid content of 20% as a pale yellow slightly cloudy liquid.

### (2) Example 1-2

60 parts of styrene, 15 parts of n-butyl methacrylate, 25 parts of dimethylaminoethyl methacrylate, 2 parts of t-dodecyl mercaptan which is a chain transfer agent, and 42.7 parts of toluene were put into a four-necked flask, heated to 105° C., added with 2 parts of dimethyl-2,2-azobis isobutylate (solubility to ethanol at 25° C.: 130 g or more/100 g ethanol) as an initiator, and allowed to polymerize at 110° C. for 3 hours. Weight average molecular weight of copolymer at this time was 35,000.

Next, 350 parts of water and 10.6 parts of 90% acetic acid were added to make the reaction water-soluble, and toluene was distilled off by distillation under heating. Thereafter, 8.9 parts of epichlorohydrin was added at 85° C. and allowed to react for 3 hours, followed by cooling and dilution in water, to give a surface sizing agent having a solid content of 20% as a pale yellow slightly cloudy liquid.

### (3) Example 1-3

50 parts of n-butyl methacrylate, 20 parts of lauryl methacrylate, 30 parts of dimethylaminoethyl methacrylate, 2 parts of t-dodecyl mercaptan which is a chain transfer agent, and 32.5 parts of isopropyl alcohol were put into a four-necked flask, heated to 85° C., added with 2 parts of 2,2-azobis-2,4-dimethylvaleronitrile (solubility to ethanol at 25° C.: 20 g/100 g ethanol) as an initiator, and allowed to polymerize at 90° C. for 3 hours. Weight average molecular weight of copolymer at this time was 48,000.

After making the reaction water-soluble by adding 335 parts of water and 12.7 parts of acetic acid, 17.7 parts of epichlorohydrin was added at 85° C. and allowed to react for 3 hours without distilling off the solvent, followed by cooling and dilution in water, to give a surface sizing agent having a solid content of 20% as a pale yellow transparent liquid.

### (4) Example 1-4

30 parts of styrene, 48 parts of isobutyl methacrylate, 22 parts of dimethylaminoethyl methacrylate, 2 parts of n-dodecyl mercaptan which is a chain transfer agent, and 47.5 parts of isopropyl alcohol were put into a four-necked flask, heated to 90° C., added with 2 parts of 2,2-azobis-2-methylbutyronitrile as an initiator (solubility to ethanol at 25° C.: 75 g/100 g ethanol), and allowed to polymerize at 90° C. for 3 hours. Weight average molecular weight of copolymer at this time was 37,000.

After making the reaction water-soluble by adding 330 parts of water and 9.3 parts of 90% acetic acid, isopropyl alcohol was distilled off by distillation under heating. Then 15.9 parts of benzyl chloride was added at 85° C. and allowed to react for 4 hours, followed by cooling and dilution in water, to give a surface sizing agent having a solid content of 20% as a pale yellow slightly cloudy liquid.

### (5) Example 1-5

50 parts of styrene, 15 parts of 2-ethylhexyl methacrylate, 35 parts of dimethylaminoethyl methacrylate, 2 parts of t-dodecyl mercaptan which is a chain transfer agent, and 47.5 parts of isopropyl alcohol were put into a four-necked flask, heated to 85° C., added with 2 parts of azobis isobutyronitrile as an initiator (solubility to ethanol at 25° C.: 2.7 g/100 g ethanol), and allowed to polymerize at 90° C. for 3 hours. Weight average molecular weight of copolymer at this time was 60,000.

After making the reaction water-soluble by adding 350 parts of water and 14.8 parts of 90% acetic acid, isopropyl alcohol was distilled off by distillation under heating. Then 20.7 parts of epichlorohydrin was added at 85° C. and allowed to react for 3 hours, followed by cooling and dilution in water, to give a surface sizing agent having a solid content of 20% as a slightly white cloudy liquid.

### (6) Example 1-6

55 parts of styrene, 15 parts of n-butyl methacrylate, 30 parts of dimethylaminoethyl methacrylate, 1.8 parts of t-dodecyl mercaptan which is a chain transfer, and 45 parts of isopropyl alcohol were put into a four-necked flask, heated to 85° C., added with 2 parts of dimethyl-2,2-azobis isobutylate (solubility to ethanol at 25° C.: 130 g or more/100 g ethanol) as an initiator, and allowed to polymerize at 90° C. for 3 hours. Weight average molecular weight of copolymer at this time was 41,000.

After making the reaction water-soluble by adding 350 parts of water and 12.7 parts of 90% acetic acid, isopropyl alcohol was distilled off by distillation under heating. Then 25.1 parts of 3-chloro-2-hydroxypropyltrimethyl ammonium chloride was added at 80° C. and allowed to react for 3 hours, followed by cooling and dilution in water, to give a surface sizing agent having a solid content of 20% as a pale yellow slightly cloudy liquid.

### (7) Comparative Example 1-1

55 parts of styrene, 45 parts of dimethylaminoethyl methacrylate, 2 parts of t-dodecyl mercaptan which is a chain transfer agent, 28.8 parts of isopropyl alcohol, and 19.1 parts of 90% acetic acid were put into a four-necked flask, heated to 85° C., added with 2 parts of t-butylperoxy 2-ethylhexanoate (organic peroxide based) as an initiator, and allowed to polymerize at 90° C. for 3 hours. Weight average molecular weight of copolymer at this time was 95,000.

After making the reaction water-soluble by adding 350 parts of water, 10.7 parts of epichlorohydrin was added at 85° C. and allowed to react for 4 hours, followed by cooling and dilution in water, to give a surface sizing agent having a solid content of 20% as a pale yellow slightly cloudy liquid.

### (8) Comparative Example 1-2

5 parts of 2-ethylhexyl acrylate, 73 parts of styrene, 22 parts of dimethylaminoethyl methacrylate, 2 parts of n-dodecyl mercaptan which is a chain transfer agent, and 60 parts of toluene were put into a four-necked flask, heated to 105° C., added with 3.5 parts of t-butylperoxyisopropyl monocarbonate (organic peroxide based) as an initiator, and allowed to polymerize at 110° C. for 3 hours. Weight average molecular weight of copolymer at this time was 121,000.

After making the reaction water-soluble by adding 336 parts of water and 9.3 parts of 90% acetic acid, toluene was distilled off by distillation under heating. Then 7.8 parts of epichlorohydrin was added at 85° C. and allowed to react for 3 hours, followed by cooling and dilution in water, to give a surface sizing agent having a solid content of 20% as a pale yellow slightly cloudy liquid.

### (9) Comparative Example 1-3

8 parts of 2-ethylhexyl acrylate, 67 parts of styrene, 25 parts of dimethylaminoethyl methacrylate, 2 parts of t-dodecyl mercaptan which is a chain transfer agent, and 60 parts of methylisobutyl ketone were put into a four-necked flask, heated to 110° C., added with 2 parts of azobis isobutyronitrile (solubility to ethanol at 25° C.: 2.7 g/100 g ethanol) as an initiator, and allowed to polymerize at 115° C. for 3 hours. Weight average molecular weight of copolymer at this time was 90,000.

After making the reaction water-soluble by adding 330 parts of water and 10.6 parts of 90% acetic acid, methylisobutyl ketone was distilled off by distillation under heating. Thereafter, 11.8 parts of epichlorohydrin was added at 85° C. and allowed to react for 3 hours, followed by cooling and dilution in water, to give a surface sizing agent having a solid content of 20% as a pale yellow transparent liquid.

### (10) Comparative Example 1-4

20 parts of 2-ethylhexyl acrylate, 35 parts of 2-ethylhexyl methacrylate, 15 parts of methylmethacrylate, 30 parts of dimethylaminoethyl methacrylate, 2 parts of t-dodecyl mercaptan which is a chain transfer agent, and 60 parts of isopropyl alcohol were put into a four-necked flask, heated to 85° C., added with 2 parts of t-butylperoxy 2-ethyl hexanoate (organic peroxide based) as an initiator, and allowed to polymerize at 90° C. for 3 hours. Weight average molecular weight of copolymer at this time was 88,000.

After making the reaction water-soluble by adding 340 parts of water and 12.7 parts of 90% acetic acid, isopropyl alcohol was distilled off by distillation under heating. Thereafter, 7.1 parts of epichlorohydrin was added at 85° C. and allowed to react for 3 hours, followed by cooling and dilution in water, to give a surface sizing agent having a solid content of 20% as a pale yellow slightly cloudy liquid.

### (11) Comparative Example 1-5

15 parts of 2-ethylhexyl acrylate, 60 parts of styrene, 25 parts of dimethylaminoethyl methacrylate, 1 part of n-dodecyl mercaptan which is a chain transfer agent, and 60 parts of methylisobutyl ketone were put into a four-necked flask, heated to 110° C., added with 2 parts of azobis isobutyronitrile (solubility to ethanol at 25° C.: 2.7 g/100 g ethanol) as an initiator, and allowed to polymerize at 115° C. for 3 hours. Weight average molecular weight of copolymer at this time was 76,000.

After making the reaction water-soluble by adding 330 parts of water and 10.6 parts of 90% acetic acid, methylisobutyl ketone was distilled off by distillation under heating. Thereafter, 11.8 parts of epichlorohydrin was added at 85° C. and allowed to react for 3 hours, followed by cooling and dilution in water, to give a surface sizing agent having a solid content of 20% as a pale yellow slightly cloudy liquid.

### (12) Comparative Example 1-6

10 parts of 2-ethylhexyl acrylate, 10 parts of n-butyl methacrylate, 55 parts of styrene, 25 parts of dimethylaminoethyl methacrylate, 4 parts of t-dodecyl mercaptan which is a chain transfer agent, and 60 parts of isopropyl alcohol were put into a four-necked flask, heated to 85° C., added with 3 parts of 2,2-azobis-2,4-dimethylvaleronitrile (solubility to ethanol at 25° C.: 20 g/100 g ethanol) as an initiator, and allowed to polymerize at 90° C. for 3 hours. Weight average molecular weight of copolymer at this time was 22,000.

After making the reaction water-soluble by adding 340 parts of water and 10.6 parts of 90% acetic acid, isopropyl alcohol was distilled off by distillation under heating. Thereafter, 13.3 parts of epichlorohydrin was added at 85° C. and allowed to react for 3 hours, followed by cooling and dilution in water, to give a surface sizing agent having a solid content of 20% as a slightly white cloudy liquid.

### (13) Comparative Example 1-7

20 parts of n-butyl acrylate, 58 parts of styrene, 22 parts of dimethylaminoethyl methacrylate, 3.5 parts of t-dodecyl mercaptan which is a chain transfer agent, and 60 parts of isopropyl alcohol were put into a four-necked flask, heated to 85° C., added with 4 parts of t-butyl peroxy-2-ethylhexanoate (organic peroxide based) as an initiator, and allowed to polymerize at less than 90° C. for 3 hours. Weight average molecular weight of copolymer at this time was 53,000.

After making the reaction water-soluble by adding 340 parts of water and 9.3 parts of 90% acetic acid, isopropyl alcohol was distilled off by distillation under heating. Thereafter, 13.0 parts of epichlorohydrin was added at 85° C. and allowed to react for 3 hours, followed by cooling and dilution in water, to give a surface sizing agent having a solid content of 20% as a slightly white cloudy liquid.

### (14) Comparative Example 1-8

5 parts of n-butyl acrylate, 74 parts of styrene, 21 parts of dimethylaminoethyl methacrylate, 2 parts of t-dodecyl mercaptan which is a chain transfer agent, and 60 parts of isopropyl alcohol were put into a four-necked flask, heated 85° C., added with 2 parts of azobis isobutyronitrile (solubility to ethanol at 25° C.: 2.7 g/100 g ethanol) as an initiator, and allowed to polymerize at 90° C. for 3 hours. Weight average molecular weight of copolymer at this time was 55,000.

After making the reaction water-soluble by adding 330 parts of water and 8.9 parts of 90% acetic acid, isopropyl alcohol was distilled off by distillation under heating. Thereafter, 5.0 parts of epichlorohydrin was added at 85° C. and allowed to react for 3 hours, followed by cooling and dilution in water, to give a surface sizing agent having a solid content of 20% as a slightly white cloudy liquid.

### (15) Comparative Example 1-9

25 parts of methyl methacrylate, 52 parts of styrene, 23 parts of dimethylaminoethyl methacrylate, 1 parts of t-dodecyl mercaptan which is a chain transfer agent, and 42.7 parts of toluene were put into a four-necked flask, heated to 105° C., added with 2 parts of azobis isobutyronitrile (solubility to ethanol at 25° C.: 2.7 g/100 g ethanol) as an initiator, and allowed to polymerize at 110° C. for 3 hours. Weight average molecular weight of copolymer at this time was 83,000.

After making the reaction water-soluble by adding 350 parts of water and 9.8 parts of 90% acetic acid, toluene was distilled off by distillation under heating. Thereafter, 6.8 parts of epichlorohydrin was added at 85° C. and allowed to react for 3 hours, followed by cooling and dilution in water, to give a surface sizing agent having a solid content of 20% as a slightly white cloudy liquid.

### (16) Comparative Example 1-10

20 parts of 2-ethylhexyl methacrylate, 50 parts of styrene, 30 parts of dimethylaminoethyl methacrylate, and 60 parts of isopropyl alcohol were put into a four-necked flask without using a chain transfer agent, heated to 85° C., added with 4 parts of t-butylperoxy-2-ethylhexanoate (organic peroxide based) as an initiator, and allowed to polymerize at 90° C.

Synthesis was stopped because gelation was observed after 1 hour from start of polymerization.

Table 1 collectively shows monomer composition, kinds of polymerization initiator and organic solvent in obtaining each copolymer in Examples 1-1 to 1-6 and Comparative examples 1-1 to 1-10, and polymerization average molecular weight of obtained copolymer.

TABLE 1

| | | | Composition(Upper stage: Type, | | | | | | | |
|---|---|---|---|---|---|---|---|---|---|---|
| | | | Lower stage: % by polymerization) | | | | | | | |
| | | | | | | | Monomer | | | |
| | | Weight | | | | | containing | Rate of | | |
| | | average | Ester | Ester | | | tertiary | quater- | | |
| | | molecular | meth- | meth- | Ester | | amino | nizing | Polymerization | |
| | | weight | acrylate | acrylate | acrylate | Styrene | group | (%) | initiator | Solvent |
| Example | 1-1 | 43,000 | — | EHMA | — | St | DMAPAA | 100 | Azobis | IPA |
| | | | | (20) | | (50) | (30) | | methylbutyronitrile | |
| | 1-2 | 35,000 | nBMA | — | — | St | DM | 60 | Dimethyl azobis | Toluene |
| | | | (15) | | | (60) | (25) | | isobutylate | |
| | 1-3 | 48,000 | nBMA | LMA | — | — | DM | 100 | Azobis | IPA |
| | | | (50) | (20) | | — | (30) | | dimethylvaleronitrile | |
| | 1-4 | 37,000 | IBMA | — | — | St | DM | 90 | Azobis | IPA |
| | | | (48) | | | (30) | (22) | | methylbutyronitrile | |
| | 1-5 | 60,000 | — | EHMA | — | St | DM | 100 | Azobis | IPA |
| | | | | (15) | | (50) | (35) | | isobutyronitrile | |
| | 1-6 | 41,000 | nBMA | — | — | St | DM | 70 | Dimethyl | IPA |
| | | | (15) | | | (55) | (30) | | azobis isobutylate | |
| Comparative | 1-1 | 95,000 | — | — | — | St | DM | 40 | t-butylperoxy | IPA |
| example | | | | | | (55) | (45) | | 2-ethylhexanoate | |
| | 1-2 | 121,000 | — | — | EHA | St | DM | 60 | t-butylperoxyisopropyl | Toluene |
| | | | | | (5) | (73) | (22) | | monocarbonate | |
| | 1-3 | 90,000 | — | — | EHA | St | DM | 80 | Azobis | MIBK |
| | | | | | (8) | (67) | (25) | | isobutyronitrile | |
| | 1-4 | 88,000 | MMA | EHMA | EHA | — | DM | 40 | t-butylperoxy | IPA |
| | | | (15) | (20) | (35) | — | (30) | | 2-ethyl hexanoate | |
| | 1-5 | 76,000 | — | — | EHA | St | DM | 80 | Azobis | MIBK |
| | | | | | (15) | (60) | (25) | | isobutyronitrile | |
| | 1-6 | 22,000 | nBMA | — | EHA | St | DM | 90 | Azobis | IPA |
| | | | (10) | | (10) | (55) | (25) | | dimethylvaleronitrile | |
| | 1-7 | 53,000 | — | — | n BA | St | DM | 100 | t-butyl peroxy-2- | IPA |
| | | | | | (20) | (58) | (22) | | ethylhexanoate | |
| | 1-8 | 55,000 | — | — | n BA | St | DM | 40 | azobis | IPA |
| | | | | | (5) | (74) | (21) | | isobutyronitrile | |
| | 1-9 | 83,000 | MMA | — | — | St | DM | 50 | azobis | Toluene |
| | | | (25) | | | (52) | (23) | | isobutyronitrile | |
| | 1-10 | — | — | EHMA | — | St | DM | — | t-butylperoxy-2- | IPA |
| | | | | (20) | | (50) | (30) | | ethylhexanoate | |

In Table 1, DM means dimethylaminoethyl methacrylate, DMAPAA means dimethylaminopropyl acrylamide, St means styrene, EHMA means 2-ethylhexyl methacrylate, nBMA means n-butyl methacrylate, IBMA means isobutyl methacrylate, LMA means lauryl methacrylate, MMA means methyl methacrylate, EHA means 2-ethylhexyl acrylate, nBA means n-butyl acrylate, IPA means isopropyl alcohol, and MIBK means methylisobutyl ketone.

Next, each newsprint paper was obtained by coating base paper of neutral newsprint paper not including an internal sizing agent with each surface sizing agent obtained in the above Examples 1-1 to 1-6 and Comparative examples 1-1 to 1-9, and sizing performance was tested for each newsprint paper in the following manner.

First, base paper of newsprint paper to be tested was prepared in the following manner.

### [Production Example of Base Paper of Newsprint Paper]

50 parts of DIP, 30 parts of TMP, 10 parts of KP, and 10 parts of GP were mixed and disaggregated to prepare a pulp slurry having freeness of 190 ml. To this slurry, calcium carbonate as a filler was added so that it occupies 2.5% per absolute dry pulp weight, and 1.5% of aluminum sulfate was added (50% by weight product as Al₂O₃.14H₂O), and the mixture was subjected to neutral papermaking by a Bel Baie Former type papermaking machine without being added with an internal sizing agent, to give base paper of newsprint paper by uncalender having basis weight of 42 g/m².

### <Examples of Newsprint Paper for Evaluation of Sizing Performance>

### (1) Example 2-1

A coating liquid containing 0.3% of surface sizing agent produced in Example 1-1, and 4.0% of oxidized starch was prepared, and on one face of base paper of newsprint paper was coated so that the liquid absorption amount was 8 g/m², and dried by a rotary drum dryer at 80° C. for 90 minutes, to prepare coated newsprint paper (newsprint paper) of Example 2-1.

### (2) Examples 2-2 to 2-6, Comparative Examples 2-1 to 2-9

Each coated newsprint paper was prepared by processing in a similar condition as in Example 2-1 except that the surface sizing agent in Example 1-1 was replaced by each surface sizing agent produced in Examples 1-2 to 1-6 or Comparative example 1-1 to 1-9.

### (3) Comparative Example 2-10

Coated newsprint paper was prepared by coating only with oxidizing starch without using a surface sizing agent.

In the above Comparative example 1-10, since a sizing agent was not obtained due to increased viscosity and gelation of copolymer in solution polymerization, it was impossible to prepare coated newsprint paper.

### <Evaluation of Sizing Performance of Newsprint Paper>

Water absorption test using 5 μL of water was conducted for each coated newsprint paper (newsprint paper) obtained in the above Examples 2-1 to 2-6 and Comparative examples 2-1 to 2-10 in accordance with JAPAN TAPPI paper and pulp test method No. 32-2 (Paper—Absorption test method—Part 2: dripping method), and sizing performance was evaluated by measuring the time (second) required for water absorption. The result is shown in Table 2 (third column from the left).

TABLE 2

| | Measurement of water absorption | | | |
|---|---|---|---|---|
| | capacity | | Soiling of PS plate | |
| | Example/ | Water absorption | Example/ | |
| Surface sizing | Comparative | capacity in 5 μL of | Comparative | Degree of soiling of |
| agent | example | water (sec.) | example | PS plate |
| Example 1-1 | Example 2-1 | 148 | Example 2-11 | ◯ |
| Example 1-2 | Example 2-2 | 150 | Example 2-12 | ◯ |
| Example 1-3 | Example 2-3 | 164 | Example 2-13 | ◯ |
| Example 1-4 | Example 2-4 | 145 | Example 2-14 | ◯ |
| Example 1-5 | Example 2-5 | 142 | Example 2-15 | Δ |
| Example 1-6 | Example 2-6 | 135 | Example 2-16 | ◯ |
| Comparative | Comparative | 121 | Comparative | X |
| example 1-1 | example 2-1 | | example 2-11 | |
| Comparative | Comparative | 138 | Comparative | X-Δ |
| example 1-2 | Example 2-2 | | example 2-12 | |
| Comparative | Comparative | 140 | Comparative | X-Δ |
| example 1-3 | example 2-3 | | example 2-13 | |
| Comparative | Comparative | 115 | Comparative | X-Δ |
| example 1-4 | example 2-4 | | example 2-14 | |
| Comparative | Comparative | 142 | Comparative | X-Δ |
| example 1-5 | example 2-5 | | example 2-15 | |
| Comparative | Comparative | 99 | Comparative | Δ |
| example 1-6 | example 2-6 | | example 2-16 | |
| Comparative | Comparative | 135 | Comparative | X-Δ |
| example 1-7 | example 2-7 | | example 2-17 | |
| Comparative | Comparative | 139 | Comparative | X-Δ |
| example 1-8 | example 2-8 | | example 2-18 | |
| Comparative | Comparative | 101 | Comparative | X-Δ |
| example 1-9 | example 2-9 | | example 2-19 | |
| Only with | Comparative | 32 | Comparative | ◯ |
| starch | example 2-10 | | example 2-20 | |

From Table 2 (third column from the left), the following finding is obtained. Comparative example 2-10 which is an example of blank without using a surface sizing agent is, of course, greatly inferior in sizing performance, and Comparative example 2-6 in which molecular weight of copolymer is smaller than the appropriate range of the present invention is also relatively inferior in sizing performance. Contrarily, among Comparative examples in which molecular weight of copolymer is larger than the appropriate range, sizing performance is in low level both in Comparative examples 2-4 and 2-9, and in Comparative example 2-1 because the former uses MMA singly or in combination as (meth)acrylic acid ester or uses a nonazoic initiator, and the latter uses too larger proportion of the monomer containing tertiary amino group.

To the contrary, in Examples 2-1 to 2-6, it is demonstrated that sizing performance is greatly improved compared to the above Comparative examples. Particularly in Example 2-3, since a long-chain ester (C12 ester) of (meth)acrylic acid is used, excellent sizing performance is observed.

In Comparative examples 2-2 to 2-3, 2-5 in which molecular weight of copolymer is larger than the appropriate range of the present invention or in Comparative examples 2-7 to 2-8 in which a nonazoic initiator is used or monomer composition condition is out of that of the present invention although molecular weight is within the appropriate range, some example shows a value similar to those of Example 2-1 to 2-6.

Next, as will be described below, base paper of newsprint paper similar to that used as newsprint paper for evaluation of sizing performance as described above was coated with each sizing agent obtained in Examples 1-1 to 1-6 and Comparative examples 1-1 to 1-9, to prepare each newsprint paper, and for each newsprint paper, degree of soiling (namely, degree of ink remaining on PS plate) of PS plate when printing was made with black ink was tested.

In this evaluation test of soiling of PS plate, an amount of surface sizing agent for coating base paper of newsprint paper was increased compared to the case of the aforementioned newsprint paper for evaluation of sizing performance so that in transfer of a surface sizing agent from coated paper to PS plate, degree of sensitization due to the transfer more clearly appeared.

### (1) Example 2-11

The surface sizing agent of Example 1-1 was mixed with a solution of oxidized starch, to prepare a coating liquid containing 4.0% by weight of oxidized starch and 1.0% by weight of surface sizing agent.

Then F side (felt side) of base paper of newsprint paper obtained in a similar manner as in Example of the coated newsprint paper for evaluation of sizing performance was coated with the coating liquid by a rubber blade so that liquid absorption amount of one side was 8 g/m², and dried in a rotary drum dryer at 80° C. for 60 seconds, to prepare newsprint paper coated with 0.32 g/m² of starch and 0.08 g/m² of surface sizing agent.

### (2) Example 2-12 to 2-16, Comparative example 2-11 to 2-19

Each coated newsprint paper was prepared in a similar condition as Example 2-11 except that the surface sizing agent of Example 1-1 was displaced by the surface sizing agent of other Examples 1-2 to 1-6 or Comparative examples 1-1 to 1-9.

### (3) Comparative Example 2-20

Coated newsprint paper was prepared by coating only with oxidized starch without using a surface sizing agent.

In the above Comparative example 1-10, it was impossible to prepare coated newsprint paper because a sizing agent was not obtained due to increased viscosity and gelation of copolymer in solution polymerization.

### <Evaluation of Anti-PS Plate-Soiling Property>

Coated side of each coated newsprint paper (newsprint paper) obtained in the above Examples 2-11 to 2-16 and Comparative examples 2-11 to 2-20 was immersed with tap water, to promote elution of the surface sizing agent, and immersed again with tap water after printing to promote washing of the surface sizing agent, and superiority or inferiority of soiling degree of PS plate (namely, anti-PS plate-soiling property) was evaluated. More concretely, for each coated newsprint paper of Examples 2-11 to 2-16, Comparative examples 2-11 to 2-20, coated face was immersed with tap water for 5 seconds, and the coated paper was bonded to nonprinting area of washed PS plate, and pressed at 49 N (5 kgf) for 5 minutes, and then the coated newsprint paper was peeled off and the PS plate was dried in air. Then RI printing was conducted with offset AF black ink on the dried PS plate, and after the printing, the PS plate was immersed with tap water for 15 seconds. This operation was repeated twice and then the ink peeling off the PS plate was washed out, and the condition of ink remaining on the PS plate was visually observed and evaluated according to the following criteria. The result is shown in Table 2 (rightmost column).

◯: no soiling observed

Δ: little soiling observed

x: soiling observed in entire face

From Table 2 (rightmost column), the following finding is obtained. That is, in Comparative examples 2-11 to 2-15, 2-19 in which molecular weight of copolymer is larger than the appropriate range of the present invention, evaluation is x or in the middle between x and Δ. Also in Comparative examples 2-17 to 2-18 in which a nonazoic initiator is used or the monomer composition condition is out of the present invention, although molecular weight of copolymer is within the appropriate range, evaluation is also low. In Comparative example 2-16 in which molecular weight of copolymer is smaller than the appropriate range, evaluation is Δ.

To the contrary, in Examples 2-11 to 2-16, evaluation is excellent. The recessive evaluation of Example 2-15 compared to other Examples may be attributable to the fact that molecular weight of copolymer is upper limit of the appropriate range of the present invention, and AIBN having low solubility to ethanol is used as an azoic initiator.

Evaluation of Comparative example 2-20 coated only with oxidized starch is excellent.

Now, superiority or inferiority of each surface sizing agent will be generally evaluated based on the foregoing results of both tests of sizing performance and anti-PS plate-soiling property shown in Table 2. In coated newspaper print of Comparative examples 2-2 to 2-3, 2-5, 2-7 to 2-8 coated with the surface sizing agent of Comparative examples 1-2 to 1-3, 1-5, 1-7 to 1-8, evaluation of sizing performance is comparable to that of Examples 2-1 to 2-6 coated with the surface sizing agent of the present invention, however, in that of Comparative examples 2-12 to 2-13, 2-15, 2-17 to 2-18 coated with the surface sizing agent of said Comparative examples, soiling is observed in the PS plate, and degree of soiling of PS plate is from x to Δ. On the other hand, in that of Comparative example 2-16 coated with the surface sizing agent of Comparative example 1-6 or in that of Comparative example 2-20 coated only with oxidized starch, evaluation of degree of soiling of PS plate is Δ to ◯, however, in that of Comparative example 2-6 coated with the surface sizing agent of said Comparative example and in that of Comparative example 2-10 coated only with oxidized starch, evaluation of sizing performance is significantly inferior.

To the contrary, in coated newsprint paper (newsprint paper) coated with Examples 1-1 to 1-6 of the present invention, evaluation is good both in sizing performance and in anti-PS plate-soiling property.

Therefore, for satisfying both the sizing performance and the anti-PS plate-soiling property, it is important to satisfy combined conditions of the present invention including molecular weight of copolymer giving surface sizing performance, composition of monomers constituting copolymer, and using of an azoic initiator and a chain transfer agent.

In the above, degree of soiling on PS plate was evaluated by testing the anti-plate-soiling property of the surface sizing agent of the present invention. In the following, degree of soiling of newsprint face is evaluated when offset printing is made on coated newsprint paper (newsprint paper).

The print evaluation test was conducted by using coated newsprint paper obtained by coating base paper of newsprint paper similar to that used for aforementioned newsprint paper for evaluation of sizing performance, with a surface sizing agent by gate roll coating.

### <Examples of Coated Newsprint Paper for Evaluation of Printing>

### (1) Example 2-17

A coating liquid containing 5% by weight of modified starch and 0.8% by weight of surface sizing agent of Example 1-1 was prepared.

Then neutral base paper of newsprint paper having internally added calcium carbonate and no sizing agent and having basis weight of 42 g/m² was coated with the above coating solution by a gate roll coater for test at a speed of 1000 m/min., to obtain coated newsprint paper (newsprint paper) having adhesion amount of modified starch of 0.5 g/m², and surface sizing agent of 0.08 g/m² in total for both faces of the newsprint paper.

### (2) Example 2-18

Coated newsprint paper was obtained by carrying out coating in a similar condition as that of Example 2-17 except that the surface sizing agent of Example 1-3 was used in place of the surface sizing agent of Example 1-1.

### (3) Comparative Example 2-21

Coated newsprint paper was obtained by carrying out coating in a similar condition as that of Example 2-17 except that the surface sizing agent of Comparative example 1-1 was used in place of the surface sizing agent of Example 1-1.

### (4) Comparative Example 2-22

Coated newsprint paper was obtained by coating only with modified starch without using a surface sizing agent.

### <Evaluation of Printing by Roland Printer (Man Roland Sheet-Fed Offset Printer)>

For each coated newsprint paper (newsprint paper) obtained in the above Examples 2-17 to 2-18 and Comparative examples 2-21 to 2-22, superiority or inferiority of degree of soiling on printing face in the case of offset printing was evaluated. More concretely, coated face of each coated newsprint paper was immersed with tap water for 5 seconds, and the coated paper was bonded on nonprinting area of washed PS plate, and dried in air, and then the coated newsprint paper was peeled off. Then, the PS plate was set in a Roland printer, and printing was made on new newsprint paper with offset AF cyan ink. Ink adhesion condition to nonprinting area on the twentieth print was visually observed, and degree of soiling on the newsprint print face was evaluated according to the following criteria. The result is shown in Table 3.

◯: no soiling observed

Δ: little soiling observed

x: soiling observed in entire face

TABLE 3

| | Surface sizing agent | Soiling by Roland printer |
|---|---|---|
| Example 2-17 | Example 1-1 | ◯ |
| Example 2-18 | Example 1-3 | ◯ |
| Comparative | Comparative | X-Δ |
| example 2-21 | example 1-1 | |
| Comparative | Not used | ◯ |
| example 2-22 | (only with starch) | |

From Table 3, following finding is obtained. That is, soiling on printing face is observed in Comparative example 2-21, however, in Examples 2-17 to 2-18 coated with a surface sizing agent of the present invention, soiling on printing face is not observed. Although this test evaluates superiority or inferiority in soiling on printing face in twentieth print in Roland printing, it is also expected that by using a surface sizing agent of the present invention, soiling (so called scumming) does not occur in the nonprinting area of PS plate, resulting that continuous printing with one plate can be realized without occurrence of soiling on the newsprint face (nonprinting area) even in actual offset printing of newspaper.

Although detailed description has been made for the cationic surface sizing agent and newsprint paper of the present invention, the scope of the present invention is not limited to the description, but may be changed or improved appropriately without departing from the spirit and scope of the present invention.

1. A cationic surface sizing agent, comprising a quaternized copolymer, of which a copolymer has a weight average molecular weight ranging from 30,000 to 60,000 and is obtained by polymerizing:
(a) 20 to 40% by weight of a monomer containing tertiary amino group;
(b) 10 to 80% by weight of a C4 to C18 alkyl ester of (meth)acrylic acid; and
(c) 0 to 70% by weight of a styrene or derivative thereof, by using an azoic polymerization initiator in the presence of a chain transfer agent.

2. The cationic surface sizing agent according to claim 1, wherein solubility (25° C.) to ethanol of the azoic polymerization initiator is 15 g/100 g or more.

3. The cationic surface sizing agent according to claim 2, wherein the azoic polymerization initiator is at least one selected from the group consisting of azobismethylbutyronitrile, dimethylazobisisobutylate and azobisdimethylvaleronitrile.

4. The cationic surface sizing agent according to claim 1, wherein 50 to 100% by mol of tertiary amino groups contained in the copolymer is quaternized by a quaternizing agent.

5. The cationic surface sizing agent according to claim 1, wherein the monomer containing tertiary amino group (a) is dialkylaminoalkyl(meth)acrylate and/or dialkylaminoalkyl(meth)acrylamide.

6. The cationic surface sizing agent according to claim 1, wherein the copolymer is obtained by solution polymerization.

7. Newsprint paper in which surface of base paper is coated with the cationic surface sizing agent according to claim 1.

8. The newsprint paper according to claim 7, wherein surface of base paper is further coated with a water-soluble high molecular compound.

9. The newsprint paper according to claim 7, wherein the base paper is paper produced by neutral papermaking.
